(19) United States
(12) Patent Application Publication
(10) Pub. No.: US 2014/0307076 A1
(43) Pub. Date: Oct. 16, 2014

(54) SYSTEMS AND METHODS FOR MONITORING PERSONAL PROTECTION EQUIPMENT AND PROMOTING WORKER SAFETY

(71) Applicant: RICHARD DEUTSCH, Raleigh, NC (US)

(72) Inventor: RICHARD DEUTSCH, Raleigh, NC (US)

(21) Appl. No.: 14/318,096

(22) Filed: Jun. 27, 2014

Related U.S. Application Data
(60) Provisional application No. 61/961,062, filed on Oct. 3, 2013.

(51) Int. Cl. G08B 21/02; G06K 9/00; H04N 7/18

(52) U.S. Cl. CPC G08B 21/02; H04N 7/188; G06K 9/00369
USPC 348/77

(57) ABSTRACT

Systems and methods for monitoring and personal protection equipment promoting worker safety are disclosed. According to an aspect, a system for promoting the safety of workers comprises a digital imaging device positioned to capture one or more images of a predetermined viewing area. Further, the system comprises an image processor operatively associated with the digital imaging device. The image processor is configured to determine whether a person is within the predetermined viewing area of the digital imaging device. The image processor is further configured to determine whether the person is not wearing required personal protection equipment. Additionally, the image processor is configured to generate a message or control signal in response to determining the person is within the predetermined viewing area of the digital imaging device and determining the person is not wearing the required personal protection equipment.

### CROSS REFERENCE TO RELATED APPLICATION

This application claims the benefit of and priority to U.S. Provisional Patent Application No. 61/961,062, filed on Oct. 3, 2013 and titled MONITORING PERSONAL PROTECTION EQUIPMENT AND WORKER SAFETY, the content of which is hereby incorporated herein by reference in its entirety.

### TECHNICAL FIELD

The field of the invention relates to electronically monitoring the presence of personal protection and safety equipment, and more specifically, to system and methods for monitoring personal protection equipment and promoting worker safety.

### BACKGROUND

Workplace safety is a concern to all those present in a hazardous environment. The National Institute for Occupational Safety and Health (NIOSH) and State-based investigation provide reports on fatal occupational injuries. Based on these reports, in 2010, there were an estimated 139,064,000 civilian workers in the U.S. private and public sector employed labor force. According to the Bureau of Labor Statistics, each day, many of these workers suffer injury, disability and/or death from workplace incidents. In 2010, more than 4,500 U.S. workers died from occupational injuries. Although difficult to enumerate, about 49,000 deaths annually are attributed to work-related illnesses. In 2010, an estimated 3.9 million workers in private industry and state and local government had a nonfatal occupational injury or illness. Of those workers, 2 million were transferred, placed on work restrictions, or took time away from work. In the same year an estimated 2.6 million workers were treated in emergency departments for occupational injuries and illnesses, and approximately 110,000 of these workers were hospitalized (NIOSH, unpublished data, 2012).

Each year occupational injuries and illnesses cause employers, workers, and society to pay tremendous costs for workers' compensation and other insurance, medical expenses, lost wages and productivity, and the personal and societal costs associated with day to day living restraints for injured and ill workers. In 2009, employers spent $74 billion on workers' compensation insurance alone.

Various detection schemes have been developed to monitor the presence of personal protective safety equipment (PPE) in the work environment. There are schemes based on the requirement of RFID tags associated with PPE items and RFID readers associated with the environment. U.S. Publication Number 2012/20001765 proposes the use of slave modules communicating with other modules. CA Publication Number CA2795136 proposes the use of computationally intensive video imaging of the individual pieces of protective equipment required while additionally imaging a workers face to determine if personal protection equipment is present along with identification for a threshold time period.

In view of the foregoing, there is a need for improved systems and techniques for monitoring personal protection equipment and promoting worker safety.

### SUMMARY OF THE INVENTION

Disclosed herein are systems and methods for monitoring personal protection equipment and promoting worker safety. According to an aspect, a system for promoting the safety of workers comprises a digital imaging device positioned to capture one or more images of a predetermined viewing area. Further, the system comprises an image processor operatively associated with the digital imaging device. The image processor is configured to determine whether a person is within the predetermined viewing area of the digital imaging device. The image processor is further configured to determine whether the person is not wearing all required personal protection equipment. Additionally, the image processor may be configured to generate a message and/or control signal in response to determining the person is within the predetermined viewing area of the digital imaging device and determining the person is not wearing all of the required personal protection equipment thereby triggering a safety violation, as an example. In an example, the present invention features a system and method to both easily and simply identify the presence of required PPE being worn by a worker at any monitored location and additionally provide a means of limiting, if not preventing, access to controlled areas and/or operation of machines requiring the wearing of same.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is an illustration showing a worker wearing personal protective equipment that includes identifying symbols and/or colors located on the PPE within view of a digital imaging device according to embodiments of the present invention;

FIG. 2 is an illustration showing representative placement of identifying symbols and/or colors on a worker's personal protection equipment shown as worker safety goggles according to embodiments of the present invention;

FIG. 3 is an illustration showing representative placement of identifying symbols and/or colors on a worker's personal protection equipment shown as gloves according to embodiments of the present invention;

FIG. 4 is an illustration showing representative placement of identifying symbols and/or colors on a worker's hearing protector according to embodiments of the present invention;

FIG. 5 is a flowchart showing an example method of operation of the system according to embodiments of the present invention; and

FIG. 6 is a flowchart showing an example method of operation of the digital imaging device and image processor to detect the presence of a worker, capture an image, determine if all require PPE are present and generate a message based on the determination according to embodiments of the present invention.

### DETAILED DESCRIPTION OF THE PREFERRED EMBODIMENTS

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, a processing circuit for the determining the presence of a worker and whether the worker is wearing all of the required PPE. In another example, a computing device may be a server or other computer located within a commercial, residential or outdoor environment and communicatively connected to other computing devices (e.g., annunciators, transducers, or computers) for the determining the presence of a worker and whether the worker is wearing all of the required PPE. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a machine, access control or computing device, and can be selected by and interacted with by a user using the user interface. In an example, the display of the computing or machine device can be a touch screen, which can display the display icon. The user can depress the area of the display screen where the display icon is displayed for selecting the display icon. In another example, the user can use any other suitable user interface of a computing device, such as a keypad, to select the display icon or display object.

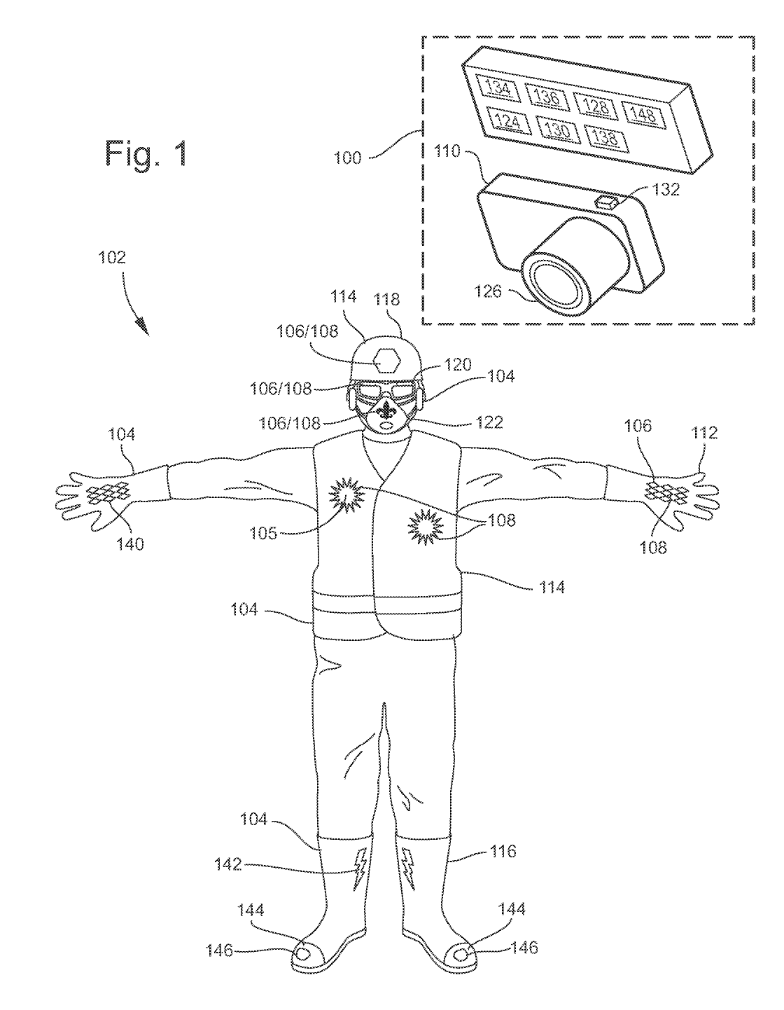

Given multiple segmentation hypotheses, the reliable recognition task is preferably accomplished by employing a convolutional network. It should be understood that the elements shown in FIGS. 1-6 may be implemented in various forms of materials, shapes and configurations according to need or preference.

The presently disclosed invention is now described in more detail. FIG. 1 is an illustration showing an example system 100 for identifying an individual 102 wearing personal protective equipment (PPE) 104 that includes identifying symbols 106 and/or colors 108 located on the PPE 104 within view of a digital imaging device 110 according to embodiments of the present invention. The PPE 104 may be comprised of gloves 112, a vest 114, boots 116, a hard hat 118, a pair of goggles 120, or a mask 122, as an example. The individual 102 may include a worker, supervisor or visitor in a residential, commercial or industrial environment, and may not include those individuals not requiring PPE 104 at that location, as a non-limiting example. For example, emergency responders may not be required to wear PPE 104 or they may have the necessary PPE 104 already. The identifying symbols 106 may be of any shape or size viewable by the digital imaging device 110 and recognizable by an image processor 124. A prominently displayed character or symbol(s) may be provided on a least one or more prominent portions of the individual piece of PPE 104 where it can easily be detected by the digital imaging device 110. A representative and detectable symbol 106 or color 108 may be also or alternatively be displayed on the back (not shown) and/or one or more other visible surfaces of the PPE 104. If identifying symbols 106 or colors 108 are placed in multiple locations, it is more likely to be detected by the digital imaging device 110 regardless of the orientation of the individual 102 or the PPE 104. In addition to being used to identify that the individual 102 is wearing the required PPE 104, the color 108 and/or symbol 106 may be used to identify whether the person is a lower level worker, supervisor or visitor. Different colors, symbols or color symbol combinations may be employed to differentiate individuals or classes of individuals through either electronic imaging or detection and analysis or simple observation. Alternatively, embodiments may use the differing colors, symbols or color symbol combinations to determine types of environments the PPE 104 may be used for. As an example, environments requiring specialized equipment, garments or PPE 104, such as, chemical, biological, or even extreme temperatures may be a determining factor or basis for the required PPE 104.

With continued reference to FIG. 1, the system 100 may also include an image processor 124. The image processor 124 is operationally coupled to the digital imaging device 110. The image processor 124 may be configured to receive both still and full-motion images from the digital imaging device 110. The digital imaging device 110 may also include a wide angle fish eye lens 126. The wide angle fish eye lens 126 may be interchanged with other types of lens, including but not limited to a zoom lens, a polarized lens, etc. Digital imaging may be also accomplished via multi lens array, stereo pair, infrared time of flight scanner/imager or structured light enabled 2D or 3D imaging, as an example. The image processor 124 may be associated with motion direction detection program instructions 128 and human form recognition program instructions 130 that isolate portions of an image. The portion of the image may include images of the human torso, legs, arms, head and hands of the detected individual 102. The image processor 124 executing the program instructions evaluates the image(s) of the at least a portion of the human form (e.g., face, torso, hands, feet, etc.) to determine if the identified symbols and/or colors present in the image match a predetermined library or list of required and/or acceptable PPE 104 items that may be associated with that individual. The symbols and/or colors may be predetermined, stored in and retrieved from a database via another computing device or server locally or remotely located. Additionally, the symbols and/or colors may be programmed into the image processor 124 via a programming button 132 on the digital imaging device 110 or processing unit 134. For example, a symbol depicting a boot may be placed on the boots worn. Thus, the symbol itself may identify the specific PPE 104 item of interest in the absence of color and body part analysis. RFID technology may also be incorporated to identify the individuals associated with the presence of the symbols or their lack thereof 106 attached or part of the PPE 104. As an alternative embodiment, the individuals associated with the presence of the symbols or within the viewing area may be identified based on facial recognition or identifiable aspects of the individual. As an example, the individual may be identified based on facial characteristics, height, iris characteristics, fingerprints or other appropriate biometric parameters.

With continued reference to FIG. 1, the system 100 may also comprise hardware, software, firmware, or combinations thereof for implementing the functionality described herein. For example, the system 100 may include at least one processor 134 and memory 136 to enable the image processor 124 to compete more complex tasks. For example, the processor 134 may be wirelessly coupled to a database (not shown) for data logging the results of each image analysis. In this manner, reporting the individual 102, date, time and items worn, as a non-limiting example. Subsequent to the image analysis described above, the system 100 may generate a message or control signal and transmit the message to an annunciator 138 or a machinery control processor 618. As an example, the message may be the control signal transmitted to the machinery control processor 618. The annunciator 138 may generate an audible, visual or sensory cued message relating to the final determination as to whether compliance with protective equipment protocol has been met. The machinery control processor 618 is provided so as to regulate area access or machine operability according to system's 100 determination of worker's compliance with PPE requirements. While the annunciator 138 may provide audible and/or visual feedback to the individual 102, the annunciator 138 may also transmit via a wireless or wired communication directly or indirectly to a receiver (not shown) at some remote location. The information transmitted may relate to the presence of the worker and his/her compliance or noncompliance with PPE requirement. As an example, if such non-compliance with safety protocol may be determined, violation information along with a time stamp and an image of the violator may be stored in memory 136 for administrative action. The system 100 may be comprised of one or more elements that may be used to perform the same functions. The processor 134 may also be configured to instruct the worker to position themselves in such a manner as to optimize visualization by the digital imaging device 110.

The system 100 provides for robust protective equipment identification for surveillance of a workplace or commercial environments that runs on a stand-alone or integral digital imaging device 110, image processor 124, memory 136 and associated programming instructions and algorithms. To meet accuracy and speed requirements, hierarchical classifiers and coarse to fine search techniques are applied at each recognition stage for localization, segmentation and classification of the resulting image(s). Efficient hierarchical decomposition of a recognition task may be employed involving coarse segmentation and classification methods. Ambiguous patterns may be forwarded to auto commands for instructing the worker to move and orient himself/herself via audio and/or visual commands so as to enhance image quality and detection when digitally imaging representative target symbols and body shapes.

With continued reference to FIG. 1, the system 100 is provided that may be configured to initially determine the presence of the individual 102 via a passive IR motion detector or by the change in a video image field (motion detection) as viewed by the digital imaging device 110. In order to minimize possible false triggering and artifact detection, the scale of such change in the image field may be of such magnitude and shape as to unlikely represent anything other than the parts of or the collective human form. The digital image device 110 in combination with the image processor 124 may be programmed such that the motion or image field sensitivity may be selectable. The selectable image field sensitivity may be set manually or programmatically via a wired or wireless coupling. Alternatively, the system 100 may also comprise image correction program instructions that may allow the image processor 124 to correct for spherical aberrations from the wide angle lens 126. U.S. Patent Application Publication Number 2005/0265619, incorporated by reference in its entirety herein, discloses a device that may be used to reduce such aberrations. A retrievable data and image storage mechanism 148, to include but not limited to removable memory such as a compact flash/SD card, may be provided to capture and retain one or more images of the individual 102 who fails to demonstrate the required PPE 104 bearing the required symbol 106. Alternatively, the system 100 may wirelessly transmit these images to a computer associated receiver (not shown) at a remote location.

Various identification systems have been developed for detecting human forms in general or specific individuals. U.S. Pat. No. 7,519,200, also incorporated by reference in its entirety herein, provides a system for recognizing persons based on facial recognition, clothing and/or text. U.S. Pat. No. 6,097,429 (incorporated in its entirety by reference herein) discloses a surveillance system that distinguishes between human and non-human forms so that detection of the latter does not signal an intrusion. One such system, as disclosed in Deutsch U.S. Pat. No. 8,320,634 (incorporated in its entirety by reference herein), detects human form, colors and symbols and determines whether the detected person may be wearing proper medical isolation garments. Additionally, various systems have been developed for recognizing colors and symbols and could be usable for the purposes of the present invention. Color detection and reference comparison are disclosed in U.S. Pat. No. 6,697,502, which is incorporated by reference in its entirety herein. Symbol detection and reference comparison are described in U.S. Patent Application Publication Number 2008/0253656 and is incorporated by reference herein. Systems have also been developed for recognizing human form, clothing and text, as discussed above.

Upon or subsequent to this anatomical area detection and analysis by the image processing system, it may then be determined if the particular area contains a specific color and/or other symbol such as a logo, QR code or indicia. The presence or absence of a color, a symbol or a combination thereof may be indicative of the general or specific identity of the worker, if identity information is desired. Image recognition as employed in optical symbol and color tracking can, for example, be used to identify a symbol associated with any particular piece of protective equipment. The detection of a symbol can also be employed to confirm the presence of a worker as opposed to some other moving object, providing redundancy to the detected change in the video image field described above or operating independently. Color detection can be used for the same purpose, but may not be as reliable as symbol detection for confirming the presence of personal protection equipment. An annunciator provides the worker or alternately other persons, an indication of the presence or absence of the anticipated color, symbol or other characteristic feature representative of the required PPE to be present when associated with that particular monitored area and pre-determined field of view.

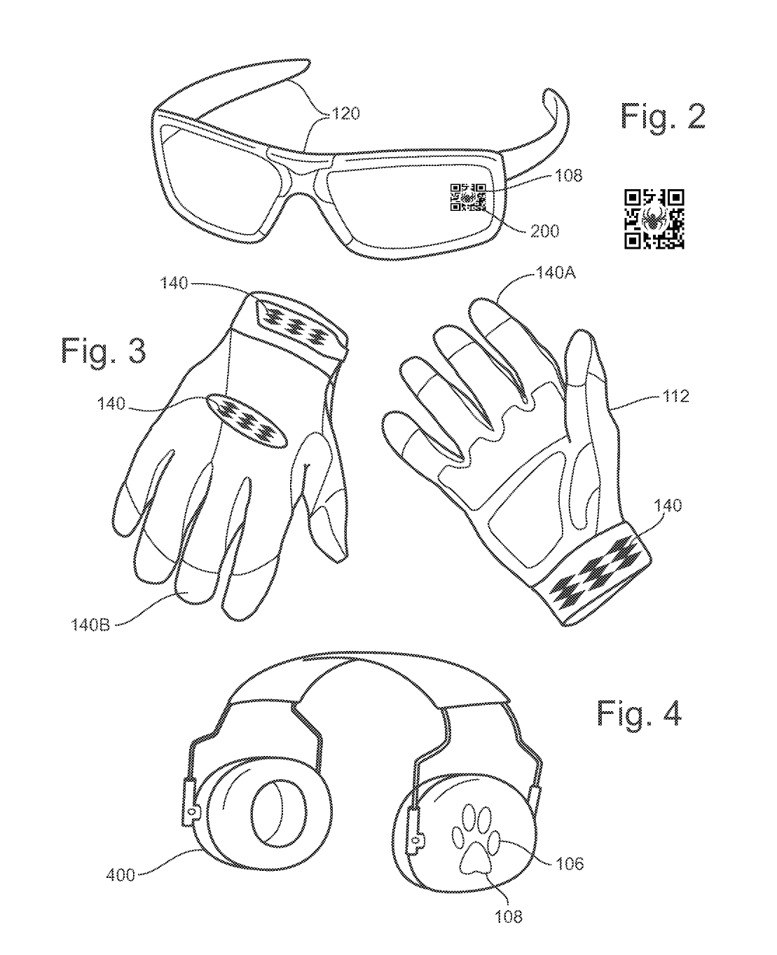

With regard to FIG. 2, an illustration showing an example of representative placement of identifying symbols 106 and/or colors 108 on the individual's 102 PPE 104 shown in FIG. 2 as safety goggles 120 may be provided according to embodiments of the present invention. The shape 106 and color 108 of the safety glasses 120 allows for ease of detection by the electronic monitoring system. As an example, a QR symbol 200 may be used independently or in combination with the color 108 for electronically identifying the specific protective item. In this manner, the symbol may be configured to convey an instruction interpretable by the image processor 124. The instruction may be an encoded web site identifying the manufacturer, safety rating or classification of the PPE 104, a name identifying the individual 102 wearing the PPE 104, or an identifying number of any kind. Additionally, a set of instructions may be encoded in the symbol that identify which doors to unlock, gates to open or other areas permissible for the individual 102 to gain access to based on the PPE 104 worn by the individual 102. Different symbols 106 may be used to electronically distinguish between different types of PPE 104, such as between hard hats 118 with representative hard hat symbol 138 and gloves 112 with representative glove symbol 140 shown in FIG. 1. Different types of safety shoes 116 with representative shoe symbols 142 and protective tips 144 with representative symbols 146 may be monitored in a similar fashion. Using solely the color of the PPE 104, the system 100 may also be capable of distinguishing between different PPE 104 items. Alternately, the color coding may provide redundancy with the PPE 104 associated symbols 106 and color(s) 108 to enhance confidence in the accuracy of required PPE 104 detection. Color(s) 108 and symbol(s) 106 on a particular piece of PPE 104 can be used to convey the same information, serving redundant functions, or to convey different information so long as at least one of them can be electronically processed for the purpose of PPE 104 identification by the system 100.

With continued reference to FIG. 2, the identity, role, employment level in the employer of the individual 102 may be identified by the symbol or color as general in nature, or capable of distinguishing, for example, worker, supervisor or visitors, or specific to a particular individual by use of multi-color combinations (e.g., blue, yellow, blue stripes, etc.). As used herein, the term “color” may refer to an individual color, a color pattern, or a combination of colors. The term symbol may be any associated geometric shape or combination of shapes representative of a symbol associated with that particular PPE 104 item. As described above the symbol 106 may be configured to convey an instruction interpretable by an image processor, such that, the PPE 104, individual 102 or permissible access is identified. Color may also be used to convey an instruction in a similar manner to the symbol. As disclosed above, RFID may also be incorporated into the PPE 104.

With regard to FIG. 3, an illustration showing representative placement of identifying symbols 106 and/or colors 108 on the individual's 102 personal protection equipment 104 shown as gloves 112 may be provided according to embodiments of the present invention. The illustration shows the glove 112 having the symbol 140 on its dorsal surface. The second symbol 140B may be the same or preferably different from the symbol 140 used to identify the collective glove 112. It will be appreciated that the palm surface of the glove 112 may be provided with the second symbol 140 in addition to or as an alternative to the dorsal location shown. Symbol 140A on the volar surface of the finger and symbol 140B on the dorsal finger surface may be provided so as to differentiate the fingers of the glove 112 from other glove components as well as indicate which side of the hand is facing the digital imaging device 110 for ease of electronic recognition by the system 100. Patterns, colors and such sub-division of symbols used for identification may be used to enhance the level of precision by the system 100. As used herein, the term patterns and symbols may be used interchangeably for ease of description. Such differentiation of specific areas of an individual piece of PPE 104 may serve to provide an enhanced level of resolution for access, machinery control and safety. The system 100 may be configured so as to detect the presence of symbols 106 and colors 108 of the fingertips of the individual's gloves 112 worn, thereby, as a non-limiting example, controlling operation of the associated machinery when such representative symbol/colors are detected in an area of danger presenting an eminent threat to the workers safety. It should be noted that detectable symbols 106 and colors 108, as well as other indicia, on the glove 112 as described above may be considered representative and is a non-limiting example of facilitating the operation of safety control devices intended to limit an individual's 102 exposure to hazardous environments.

As an alternative embodiment, the placement of an identifying symbol 106 or color 108 on a particular piece of PPE 104 may serve as a means of personal protection for machine operation. As an example, the safety of a machine operators hands may be further protected, wherein the system 100 electronically detects the required PPE 104 using the associated indicia by including a means to activate a worker oriented annunciator 138 or restricting power or access to such machine when a placement of the workers hand(s) may be detected in a perilous location. Similarly, in a second example, the system 100 may preclude the operation of a machine or worker access to potentially perilous work areas by a means that electro-optically associates the detection of the presence or absence of a representative symbol 106 or color 108 with the operation of an automated gate, elevator or other conveyance. As an alternate means of worker safety protection, the activation of a warning annunciator 138 may be used when the lack of safety glasses or goggles 120 or other PPE 104 is not present as determined by the system 100. The term machine may be defined as any device with moving parts having the potential to injure the worker or others.

With regard to FIG. 4, an illustration showing representative placement of identifying symbols 106 and/or colors 108 on the PPE 104 shown as a hearing protector 400 may be provided according to embodiments of the present invention. In a similar, non-limiting manner to the goggles 120 described in FIG. 3, the hearing protector 400 may incorporate a detectable symbol 106 or color 108. As similarly described in FIG. 3, detecting the hearing protector 400 and associated symbol 106 or color 108 may limit or provide for operation of machinery, access to areas, etc.

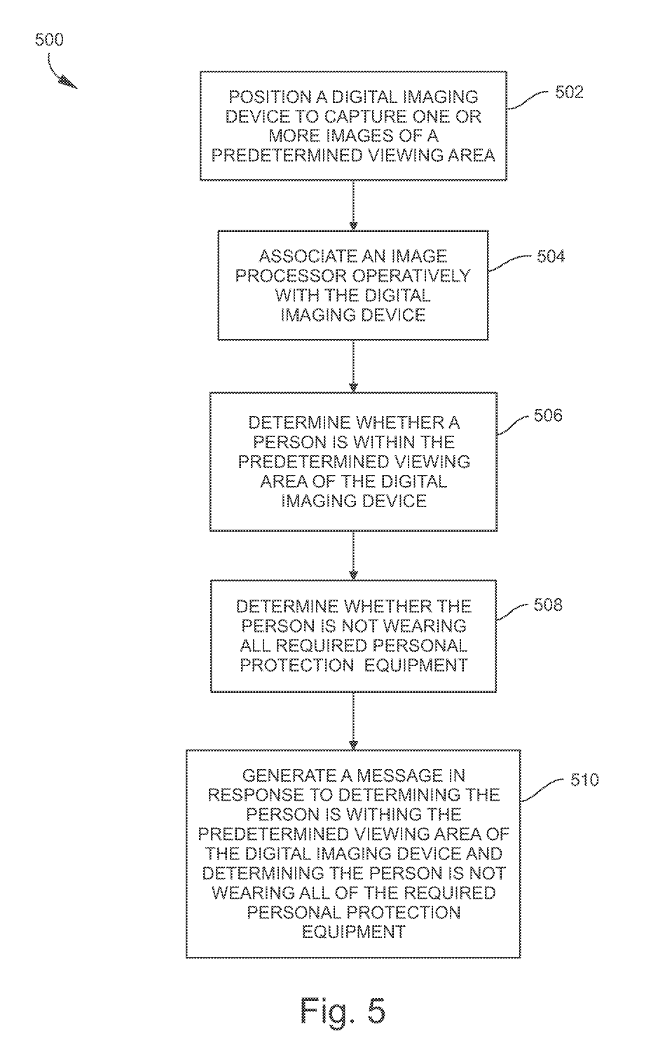

Referring to FIG. 5, a flowchart showing an example method 500 of operation of the system 100 for monitoring personal protection equipment may be provided according to embodiments of the present invention. It is noted that reference is made to FIG. 1 as implementing the examples described for FIG. 5, although it should be understood that any suitably configured system can implement the method of FIG. 5.

Referring to FIG. 5, the method includes positioning 502 the digital imaging device 110 to capture one or more images of a predetermined viewing area. For example, the system 100 shown in FIG. 1 may capture one or more images of a predetermined viewing area. The method includes associating 504 an image processor 124 operatively with the digital imaging device 110. Alternatively, the method may include associating multiple image processors 124 with digital imaging devices 110 with the system 100. Further, the method includes determining 506 whether a person or individual 102 may be within the predetermined viewing area of the digital imaging device 110. In addition, the method then includes determining 508 whether the person may not be wearing all required personal protection equipment 104. Further, the method includes generating 510 a message in response to determining the person may be within the predetermined viewing area of the digital imaging device 110 and determining the person may not be wearing all of the required personal protection equipment 104.

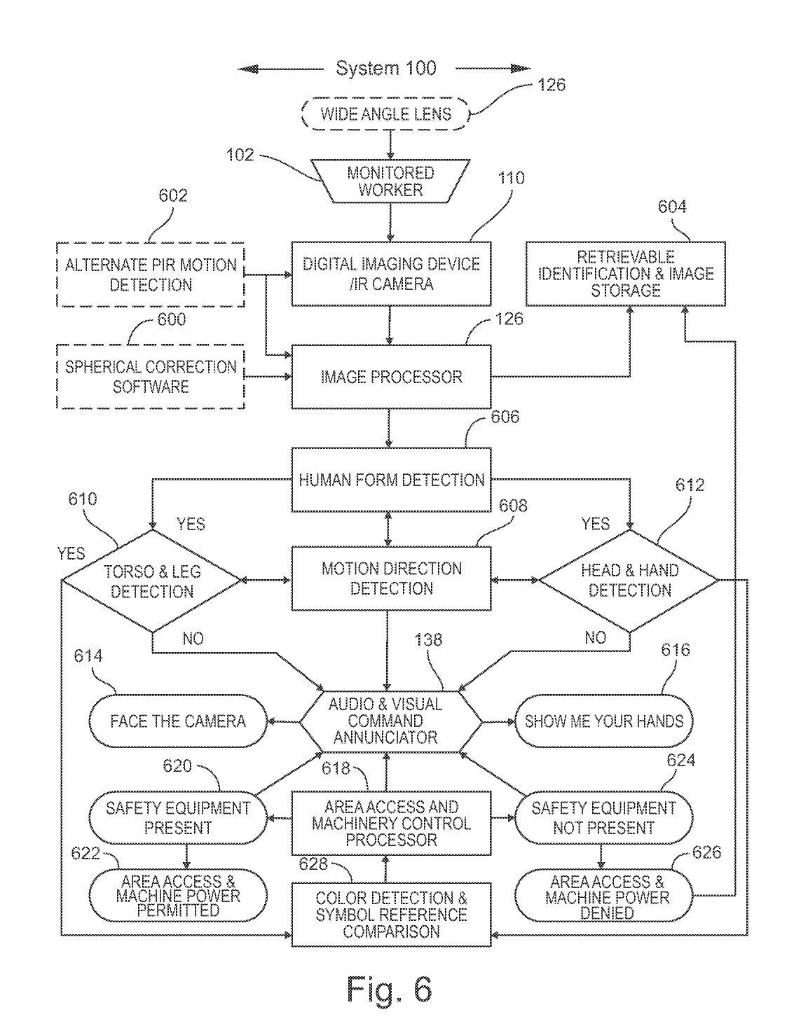

FIG. 6 illustrates a flowchart showing an example method of operation of the system 100 comprising the digital imaging device 110 and the image processor 124 for detecting the presence of the individual, determine if all required PPE 104 are present and generating a message based on the determination may be provided according to embodiments of the present invention. The optional wide angle optical lens 126 may be affixed to the digital imaging device 110. The digital imaging device 110 may be positioned in a work area, which may be a job site, factory floor, or commercial/industrial area where one or more pieces of personal safety equipment is required. The individual 102 or worker may be viewed from the waist up, head up and/or feet alone within a predetermined viewing area of the digital imaging device 110. The predetermined viewing area may be an area sufficient for proper viewing of the individual 102 and any worn PPE 104 with sufficient resolution to determine the type of indicia placed on the PPE 104, whether shape or color based. The predetermined viewing area may not include everything viewed by the lens 126, but rather a specific area of the worker's environment. Corrective program instructions 600 associated with the image processor 124 may be provided so as to correct spherical distortions caused by wide angle lens 126 or other lens that may be deemed appropriate for sufficient detection of symbols 106 and colors 108 in the environment as described above. Alternatively, the digital imaging device 110 may use an IR illumination and detection scheme 602 for detection of the individual 102 and/or PPE 104 in environments requiring such enhanced image detection. The image processor 124 may be operatively associated with a logic program including software routines, memory and storage 604 to perform multi-resolution image analysis, and save analyzed images as an example.

With continued reference to FIG. 6, different resolutions of the image may be analyzed to assist in object recognition. Initial resolution may be defined by detection of any large, presumably human object detection 606 changing the background scene as determined by the motion direction detection routine 608. A system for detecting directional motion 608 is disclosed in U.S. Pat. No. 6,707,486 to Millet et al., the disclosure of which is incorporated by reference in its entirety herein. Human form detection and background subtraction by the human object detection 606 further refines the detection scheme as coarse localization focuses in on the human form within the captured image to reduce the number of pixels and thereby reduce the computational complexity. Edges of the image are computed and a saliency map (not shown) may be generated. After successful localization and multiple segmentations, the saliency map blends edges to achieve intensity regions in the image. Highest peak values in the intensity regions have the highest probability of being the subject individual 102 and are selected for further processing. Based on local edges and regional features, a refinement of an area of interest may be determined for localization in the torso detection routine 610 and arm/hand detection routine 612. Hand detection routines are disclosed, for example, in U.S. Patent Application Publication Number 2002/0090146 to Heger and U.S. Pat. No. 6,252,598 to Segen, both of which are incorporated by reference in their entireties herein. Segmentation provides locations that are likely to include the desired items to be detected. This includes addressing illumination effects, positions, rotations, and distances of the worker from the camera. Comparisons to normalized correlation models or templates are performed to find similar illuminations, distances, orientations etc. in order to facilitate the removal of the ambient background from the image. To reduce illumination effects on the image, before classification, each sub-image may be normalized with respect to brightness and contrast. This sub-image minus the ambient background preferably has a fixed sized so as to reference against a library of know shapes and forms. Since the segmentation process itself may be inherently ambiguous, it may be preferably coupled to the symbols shape for identification.

With continued reference to FIG. 6, after successful localization, multiple segmentation hypotheses are created by an algorithm based on non-linear projections onto a baseline image. The system 100 may employ a convolutional neural network classifier or other statistical classifier which identifies each associated PPE 104 symbol 106 and/or color 108 and returns a confidence value for each item detected. Based on the confidence measure, the segmentation hypotheses with the highest overall confidence may be accepted or, if the confidence level does not meet a predetermined level of reliability, an audio command annunciator 138 may issue a set of positioning instructions 614, 616 to the detected individual 102 instructing the individual 102 to alter their position or orientation with respect to the digital imaging device 110 so as to improve the quality of the image undergoing analysis. Such instructions can also be provided upon the first detection of human motion within the selected area so that the individual 102 can immediately assume a position that may be conducive to imaging PPE 104 associated symbols/colors and subsequent PPE 104 detection or confirmation of lack thereof. For example, an area may only require goggles 120 or safety glasses and the system 100 may instruct the individual 102 to face the digital imaging device 110 immediately upon detecting the presence of an individual 102 in the area.

With continued reference to FIG. 6, as described above in FIG. 3, an area access and machinery control processor 618 may be used to control access to both areas and machinery. For example, if the required PPE 104 is present 620, access to an area and/or a machine, or power may be permitted 622. If the required PPE 104 is not present 624, access to an area and/or a machine, or power may be denied 626. Further disclosed, the system 100 may be configured to provide feedback to the individual 102 via the annunciator 138 that safety equipment is either present 620 or not present 624. The system 100 may also provide feedback to the individual 102 that access is permitted or denied.

The fine localization of the sub-image based on segmentation and edge detection creates an image that may be processed by the symbol/color detection and reference comparison routine 628. Such comparison is accomplished by analyzing the color histograms of the sub-image to a reference table or database (not shown) reflecting color composition of the anticipated specific PPE 104. The positive correlation of the color 108 of the sub-image to a specific color/pattern contained within a color reference table may be of interest to the system 100 as it indicates a high probability of the presence of the desired PPE 104. When color correlation has been established, the sub-image undergoes additional analysis for the presence of a specific symbol 106 by the symbol/color detection and reference comparison routine 628.

Additionally, the presence of the individual 102 violating safety protocol with/without the proper PPE 104 may be documented by a series of images to be wired or wirelessly recorded on a fixed or removable, local or remote memory 604 associated with image processor 124 or alternate imaging device (not shown) for archival purposes and potential administrative action. Alternately, pre or post safety protocol violation images of the violating individual 102 acquired by digital imaging device 110 may be transmitted via a wired or wireless connection to a remotely located central computer system (not shown) for observation, compilation, storage and action. It is further anticipated that the system 100 may further comprise an override configuration such that a master symbol, master color or some other physical key may be used to override the system in the event of an emergency or other need.

With continued reference to FIG. 6, an alternate configuration of the system 100 utilizing the PIR based motion detector 602 may be included in addition to the system 100 as a means to conserve energy and minimizing wear on the system 100 described above. Requiring minimal power to function, the power saving function may awake the digital imaging device 110 and image processor 124 and optionally, the associated processors, from a power conserving sleep state when initially detecting motion by the individual 102 in the area under surveillance. A digital color camera is described by U.S. Pat. No. 6,642,956, which is incorporated by reference in its entirety herein. Such a camera may be employed as the digital imaging device 110 in the system described herein.

With continued reference to FIG. 6, the system 100 may be implemented in various forms of hardware, software or combinations thereof. The elements of FIG. 6 are preferably implemented in firmware and software on one or more appropriately programmed general purpose digital processing units having a processor and memory and input/output interfaces. While equipment identification preferably involves conducting all of the steps shown in FIG. 6, the presence and identity of an individual piece of PPE 104 could be determined by just detecting the visible symbol 106 on the PPE 104 that may be associated with and identifies that particular piece of PPE 104. If symbol and shape detection is to be the primary means of PPE determination, as may be required in some low light environments or other optically limited work environments, infrared illumination and IR digital imaging of the subject individual 102, the worn PPE 104 and the work related safety threats may be employed. Additionally, the incorporation of IR reflective materials and IR reflective inks may be employed by the indicia to enhance low light symbol and shape detection by system 100. This optional configuration eliminates the need for bright or full spectrum illumination for detection. The steps of color detection may be omitted in this simplified procedure. Where acceptable, such limited means of detection may be employed at the expense of a decreased level of confidence in PPE detection through loss of color detection.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the systems computer, partly on the systems computer, as a stand-alone software package, partly on the systems computer and partly on a remote computer or entirely on the remote computer or server. In the latter scenario, the remote computer may be connected to the systems computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A system for promoting the safety of persons comprising:
a digital imaging device positioned to capture one or more images of a predetermined viewing area; and
an image processor operatively associated with the digital imaging device and configured to:
determine whether a person is within the predetermined viewing area of the digital imaging device;
determine whether the person is not wearing required personal protection equipment; and
generate a message in response to determining the person is within the predetermined viewing area of the digital imaging device and determining the person is not wearing the required personal protection equipment.

2. The system of claim 1, wherein the image processor is further configured to determine if the person is not wearing required personal protection equipment based on one or more colors.

3. The system of claim 2, wherein the image processor is further configured to determine if required personal protection equipment comprises of one or more symbols.

4. The system of claim 1, wherein the image processor is further configured to determine if the person is not wearing required personal protection equipment based on one or more symbols.

5. The system of claim 1, wherein the image processor is further configured to cause an annunciator to generate an instructional message to instruct the person to position themselves within the predetermined viewing area of the digital imaging device.

6. The system of claim 5, wherein the image processor is further configured to determine if the person is not wearing required personal protection equipment based on referencing an image database.

7. The system of claim 1, wherein the image processor is further configured to detect motion within a pre-determined field of view of the digital imaging device attributable to human motion.

8. The system of claim 1, wherein the image processor is further configured to detect motion within a pre-determined field of view of the digital imaging device attributable to human motion based on at least one portion of a human body.

9. The system of claim 8, wherein the at least one portion of a human body comprises a human face.

10. The system of claim 1, wherein the image processor is further configured to retrieve identification information of the person if it is determined the person is not wearing required personal protection equipment.

11. The system of claim 10, wherein the image processor is further configured to store the identification information of the person in a database.

12. The system of claim 10, wherein the image processor is further configured to prevent the person from entering a designated area if it is determined the person is not wearing required person protection equipment.

13. The system of claim 10, wherein the image processor is further configured to prevent the person from operating a designated piece of machinery if it is determined the person is not wearing required personal protection equipment.

14. A method for promoting the safety of persons, the method comprising:
positioning a digital imaging device to capture one or more images of a predetermined viewing area;
associating an image processor operatively with the digital imaging device;
determining whether a person is within the predetermined viewing area of the digital imaging device;
determining whether the person is not wearing required personal protection equipment; and
generating a message in response to determining the person is within the predetermined viewing area of the digital imaging device and determining the person is not wearing the required personal protection equipment.

15. The method of claim 14, further comprising determining if the person is not wearing required personal protection equipment based on one or more colors.

16. The method of claim 15, wherein the image processor is further configured to determine if required personal protection equipment comprises of one or more symbols.

17. The method of claim 14, further comprising determining if the is not wearing required personal protection equipment based on one or more symbols.

18. The method of claim 14, further comprising causing an annunciator to generate an instructional message to instruct the person to position themselves within the predetermined viewing area of the digital imaging device.

19. The method of claim 18, further comprising determining if the person is not wearing required personal protection equipment based on referencing an image database.

20. The method of claim 14, further comprising detecting motion within a pre-determined field of view of the digital imaging device attributable to human motion.

21. The method of claim 14, further comprising detecting motion within a pre-determined field of view of the digital imaging device attributable to human motion based on at least one portion of a human body.

22. The method of claim 21, wherein the at least one portion of a human body comprises a human face.

23. The method of claim 14, wherein the image processor is further configured to retrieve identification information of the person if it is determined the person is not wearing required personal protection equipment.

24. The method of claim 23, wherein the image processor is further configured to store the identification information of the person in a database.

25. The method of claim 23, wherein the image processor is further configured to prevent the person from entering a designated area if it is determined the person is not wearing required personal protection equipment.

26. The method of claim 23, wherein the image processor is further configured to prevent the person from operating a designated piece of machinery if it is determined the person is not wearing required personal protection equipment.

27. A personal protection piece of equipment comprising:
a symbol positioned in a visible portion of the personal protection equipment for imaging by a digital imaging device, wherein the symbol conveys an instruction interpretable by an image processor.

28. The personal protection piece of equipment of claim 27, wherein the symbol conveys the instruction based on a color.

29. The personal protection piece of equipment of claim 28, wherein the symbol conveys the instruction based on a color and a shape of the symbol.

30. The personal protection piece of equipment of claim 27, wherein the symbol conveys the instruction based on an embedded code in the symbol.

31. The personal protection piece of equipment of claim 27, wherein the symbol is a QR code.
